(19) United States
(12) Patent Application Publication
(10) Pub. No.: US 2026/0156310 A1
(43) Pub. Date: Jun. 4, 2026

(54) System And Method For Switching To Alternate Ott Application During Cdn Congestion

(71) Applicant: TiVo Platform Technologies LLC, San Jose, CA (US)

(72) Inventors: Sai Krishna Chaitanya, Bengaluru (IN); Srikanth Channapragada, Bangalor (IN); Madhav Birla, Pali (IN); Rishi Raj, Motihari (IN)

(73) Assignee: TiVo Platform Technologies LLC, San Jose, CA (US)

(21) Appl. No.: 19/409,281

(22) Filed: Dec. 4, 2025

(30) Foreign Application Priority Data
Dec. 4, 2024 (IN) 202441095841

(51) Int. Cl. H04N 21/24; H04N 21/84

(52) U.S. Cl. CPC H04N 21/2404; H04N 21/84

(57) ABSTRACT

A method for switching to an alternate over-the-top (OTT) application when congestion occurs in a content delivery network (CDN) during media content streaming is disclosed. The method includes detecting interruptions, associated with congestion in the CDN, in the playback of media content on a primary OTT application. Next, the method includes retrieving metadata associated with the media content on the primary OTT application, including at least title and playback position. Then, the method includes identifying an alternate OTT application capable of providing access to the same media content based on the retrieved metadata and prioritizing alternate OTT applications based on user preferences and subscription status. Thereafter, the method includes transitioning playback to the identified alternate OTT application from the point where the interruption occurred, thereby allowing seamless continuation of the media content.

### BACKGROUND

### Cross Reference to Related Cases

The present application claims priority from Indian Application No. 202441095841 filed Dec. 4, 2024, the disclosure of which is hereby incorporated herein by reference.

### Technical Field

The present disclosure relates to the field of digital media streaming, and particularly relates to systems and methods for switching to alternate Over-The-Top (OTT) application during Content Delivery Network (CDN) congestion.

### Description of the Related Art

The demand for seamless media streaming over the internet has surged and is largely driven by the rise of over-the-top (OTT) applications. Such OTT applications deliver video and/or audio content directly to users over a network connection bypassing traditional broadcast methods and relying on content delivery networks (CDNs) to distribute content efficiently. Although such CDNs enhance the speed and reliability of content delivery by caching data on geographically distributed servers, but the CDNs are subject to varying levels of congestion that can negatively impact streaming quality and result in interruptions, buffering, and/or reduced video resolution/audio quality. Generally, the CDN congestion is due to overloading of the CDN that may be due to high demand, network outages, or limited server resources, causing playback disruptions that degrade the user experience. Further, at the user level, only slow streaming and heaving buffering may be visible making CDN congestion difficult for users to identify and/or remedy the issue since congestion at the network level is largely invisible from the user's perspective.

Presently, when the CDN experiences an overload, existing systems may either send an error code or attempt to mitigate the issue through fallback mechanisms, such as using internal logic of the device (like a load balancer) to retry content delivery requests on alternate servers or may attempt to reconnect after a delay. However, these fallback mechanisms are not effective in preventing playback interruptions. While waiting for the CDN or edge server to recover, clients may experience extended buffering times, and in many cases, playback may revert to lower resolutions to compensate for limited bandwidth.

Therefore, there is a need for improved methods and systems that allow users to continue uninterrupted playback and overcomes the above-mentioned drawbacks.

### BRIEF SUMMARY

One or more embodiments are directed to a system and method (hereinafter may also be termed “mechanism”) for switching to an alternate over-the-top (OTT) application when congestion occurs in a content delivery network (CDN). The disclosed mechanism in the present disclosure provides addresses interruptions and buffering issues encountered during media streaming due to content delivery network (CDN) congestion by proactively detecting the CDN congestion and enabling seamless switching to an alternate over-the-top (OTT) application to continue uninterrupted playback. The mechanism is designed to enhance the user's streaming experience by maintaining the continuity of playback, minimizing delays, and ensuring high-quality content delivery.

In an embodiment, the mechanism operates through a dual-phase process: detection and resolution. In the detection phase, the mechanism monitors the ongoing streaming session for signs of interruption, which may include buffering, slower data retrieval rates, or quality downgrades caused by congestion in the CDN. Unlike conventional solutions that wait for severe buffering or playback halts, the mechanism continuously evaluates the streaming conditions, enabling it to recognize potential interruptions before they noticeably impact the user experience.

Upon detecting potential congestion, the mechanism retrieves critical playback information, such as the media asset's title, episode details, and the current play position. This metadata allows the mechanism to locate the content on other OTT applications, thereby enabling playback to resume from the exact point of interruption. Using a search capability that connects to an OTT content directory or database, the mechanism identifies alternate platforms that host the same content. The mechanism considers various options, including both installed and non-installed OTT applications on the user's device, expanding the scope of alternatives for uninterrupted playback.

Once an alternate OTT application is identified, the mechanism prompts the user with the option to switch to the recommended OTT service. The mechanism is designed to minimize user intervention by presenting only relevant options for resuming playback. In cases where the user accepts the switch, the mechanism uses the previously retrieved play position data to synchronize the playback on the new OTT application, ensuring that the content continues from the same scene or timestamp. This seamless handover preserves the continuity of the streaming session, avoiding rebuffering or playback disruptions. Additionally, the mechanism considers user preferences and login states across various OTT applications, thereby prioritizing alternate OTT services where the user is already signed in or frequently streams content. This preference-based approach streamlines the recommendation process and enhances user satisfaction by selecting the most accessible options. Thus, the mechanism significantly improves the streaming experience by reducing buffering, eliminating extended playback delays, and maintaining video quality despite CDN limitations.

An embodiment of the present disclosure discloses the system for switching to an alternate over-the-top (OTT) application when congestion occurs in a content delivery network (CDN). The system includes a monitoring module that detects interruptions in the playback of media content on a primary OTT application, where these interruptions are associated with CDN congestion. This detection may be achieved by analyzing playback logs for deviations in expected video or audio data frequency, capturing and analyzing screenshots for buffering indicators using an object detection model, or inspecting the document object model (DOM) of the streaming application to identify elements associated with buffering states. The monitoring module may also preemptively detect potential interruptions by monitoring the prefetch rate of video or audio segments and comparing it to an expected rate.

Further, the system includes a content retrieval module gathers, when an interruption is detected, metadata from the primary OTT application, including the title and playback position of the media content, enabling the system to locate the same content on other OTT platforms. The system also includes a content search module that identifies alternate OTT applications capable of providing access to the same media content based on this metadata. The identification of alternate OTT applications may include determining if the alternate OTT application is installed on the user's device and, if so, providing a deep link to facilitate the switch. The content search module may also search a third-party catalog for the availability of the media content on various OTT applications and rank these options based on user preferences and login status.

The system also includes a user preference module that prioritizes alternate OTT applications according to the user's subscription status and preferences, optimizing the selection process for a smoother transition. Further, the system includes a switching module that initiates, once an appropriate alternative is identified, the transition of playback to the selected OTT application from the exact point of interruption. To ensure a seamless viewing experience, the switching module uses the playback position data retrieved earlier, transmitting it to the new OTT application so that playback resumes precisely where it left off on the primary OTT platform. In addition, the system allows playback to be restored from the same scene or timestamp by retrieving the title, episode details, and play position before switching. This approach minimizes disruptions by selecting the highest-ranked alternative based on user preferences and ensuring continuity in playback despite CDN congestion.

An embodiment of the present disclosure discloses a method for switching to an alternate over-the-top (OTT) application when congestion occurs in a content delivery network (CDN). The method includes the steps of detecting interruptions in the playback of media content on a primary OTT application, where these interruptions are associated with CDN congestion. This detection may be achieved by analyzing playback logs for deviations in expected video or audio data frequency, capturing and analyzing screenshots for buffering indicators using an object detection model, or inspecting the document object model (DOM) of the streaming application to identify elements associated with buffering states. Further, detection of interruptions may include preemptively detect potential interruptions by monitoring the prefetch rate of video or audio segments and comparing it to an expected rate.

Further, the method may include the steps of retrieving, when an interruption is detected, metadata from the primary OTT application, including the title and playback position of the media content, enabling the system to locate the same content on other OTT platforms. Next, the method may include the steps of identifying alternate OTT applications capable of providing access to the same media content based on this metadata. The identification of alternate OTT applications may include determining if the alternate OTT application is installed on the user's device and, if so, providing a deep link to facilitate the switch. Alternatively, or additionally, identifying the alternate OTT application may include searching a third-party catalog for the availability of the media content on various OTT applications and rank these options based on user preferences and login status.

Next, the method may include the steps of prioritizing alternate OTT applications according to the user's subscription status and preferences, optimizing the selection process for a smoother transition. Thereafter, the method may include the steps of initiating, once an appropriate alternative is identified, the transition of playback to the selected OTT application from the exact point of interruption. To ensure a seamless viewing experience, the method may utilize the playback position data retrieved earlier, transmitting it to the new OTT application so that playback resumes precisely where it left off on the primary OTT platform. In addition, the method may allow playback to be restored from the same scene or timestamp by retrieving the title, episode details, and play position before switching.

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary environment having a system for switching to an alternate over-the-top (OTT) application when congestion occurs in a content delivery network (CDN), in accordance with an embodiment of the present disclosure.

FIG. 2 illustrates a block diagram of the system for switching to the OTT application when congestion occurs in the CDN, in accordance with an embodiment of the present disclosure.

FIGS. 3A-3C illustrate exemplary implementations of the system for switching to the OTT application when congestion occurs in the CDN, in accordance with an embodiment of the present disclosure.

FIGS. 4A-4B illustrates exemplary implementations of the system for switching to a subscribed alternate OTT application, in accordance with an embodiment of the present disclosure.

FIGS. 5A-5C illustrates exemplary implementations of the system for switching to an unsubscribed alternate OTT application, in accordance with an embodiment of the present disclosure.

FIG. 6 illustrates a flow chart for an operation of the system for switching to the OTT application when congestion occurs in the CDN, in accordance with an embodiment of the present disclosure.

FIG. 7 is a flow chart of a method for switching to the OTT application when congestion occurs in the CDN, in accordance with an embodiment of the present disclosure.

FIG. 8 illustrates an exemplary computer unit in which or with which embodiments of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to a system and method (hereinafter may also be termed “mechanism”) for switching to an alternate over-the-top (OTT) application when congestion occurs in a content delivery network (CDN). The disclosed mechanism in the present disclosure provides addresses interruptions and buffering issues encountered during media streaming due to content delivery network (CDN) congestion by proactively detecting the CDN congestion and enabling seamless switching to an alternate over-the-top (OTT) application to continue uninterrupted playback. The mechanism is designed to enhance the user's streaming experience by maintaining the continuity of playback, minimizing delays, and ensuring high-quality content delivery.

In an embodiment, the mechanism operates through a dual-phase process: detection and resolution. In the detection phase, the mechanism monitors the ongoing streaming session for signs of interruption, which may include buffering, slower data retrieval rates, or quality downgrades caused by congestion in the CDN. Unlike conventional solutions that wait for severe buffering or playback halts, the mechanism continuously evaluates the streaming conditions, enabling it to recognize potential interruptions before they noticeably impact the user experience.

Upon detecting potential congestion, the mechanism retrieves critical playback information, such as the media asset's title, episode details, and the current play position. This metadata allows the mechanism to locate the content on other OTT applications, thereby enabling playback to resume from the exact point of interruption. Using a search capability that connects to an OTT content directory or database, the mechanism identifies alternate platforms that host the same content. The mechanism considers various options, including both installed and non-installed OTT applications on the user's device, expanding the scope of alternatives for uninterrupted playback.

Once an alternate OTT application is identified, the mechanism prompts the user with the option to switch to the recommended OTT service. The mechanism is designed to minimize user intervention by presenting only relevant options for resuming playback. In cases where the user accepts the switch, the mechanism uses the previously retrieved play position data to synchronize the playback on the new OTT application, ensuring that the content continues from the same scene or timestamp. This seamless handover preserves the continuity of the streaming session, avoiding rebuffering or playback disruptions. Additionally, the mechanism considers user preferences and login states across various OTT applications, thereby prioritizing alternate OTT services where the user is already signed in or frequently streams content. This preference-based approach streamlines the recommendation process and enhances user satisfaction by selecting the most accessible options. Thus, the mechanism significantly improves the streaming experience by reducing buffering, eliminating extended playback delays, and maintaining video quality despite CDN limitations.

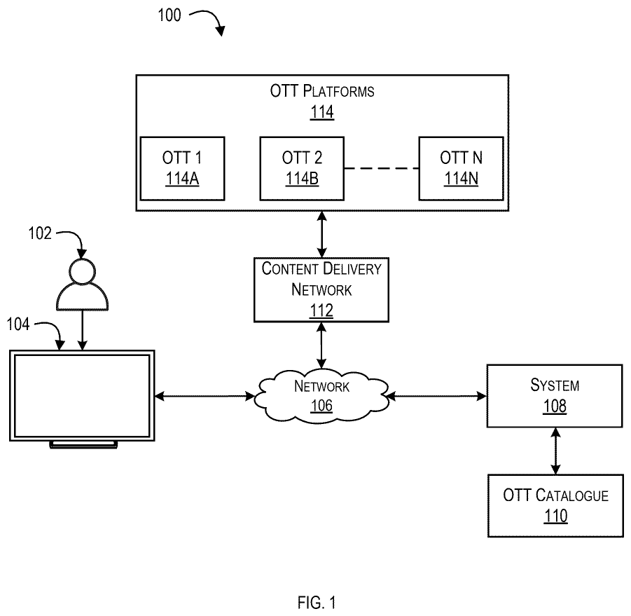

FIG. 1 illustrates an exemplary environment 100 having a system 108 for switching to an alternate over-the-top (OTT) application when congestion occurs in a content delivery network (CDN), in accordance with an embodiment of the present disclosure. In an embodiment, the exemplary environment 100 may include a user 102, a user device 104, a network 106, the system 108, an OTT catalog 110, the CDN 112, and one or more OTT platforms 114A, 114B, . . . , 114N (hereinafter terms as OTT platforms 114 or OTT applications 114). The user 102 may correspond to an individual accessing media content through one of multiple OTT platforms over the network 106. The user 102 may interact with media streaming applications on the user device 104, typically selecting, playing, and managing content, and may have preferences for certain OTT platforms, possibly determined by factors such as subscription status, familiarity, and preferred content. The user device 104, for the purpose of this disclosure, may be any electronic device used to access media streaming services, such as a smartphone, tablet, laptop, smart TV, or desktop computer. The user device 104 may connect to the network 106 to request, receive, and play media content from the OTT platforms 114. In an embodiment, the user device 104 may include software to render media playback and may have multiple OTT platforms 114 installed, each capable of streaming media. It may be apparent to a person skilled in the art that variations of the user device 104 may support different operating systems (e.g., iOS, Android, Windows) and offer different levels of performance, affecting streaming quality and response times.

In an embodiment, the network 106 may be a medium through which the user device 104 may communicate with content sources, including the OTT platforms 114 and other services involved in the content delivery process. Further, the network 106 may include wired or wireless connections, such as Wi-Fi, mobile data (3G, 4G, or 5G), and broadband, which may vary in speed, stability, and bandwidth. It may be apparent to a person skilled in the art that the network 106 may be susceptible to congestion, which may affect media streaming quality, leading to buffering and interruptions for the user 102. In an embodiment, the CDN 112 may be a distributed network of servers strategically placed across geographic locations to efficiently deliver media content to the user devices 104. Typically, the CDN 112 may help reduce latency by caching content on edge servers near the user's location, but, during periods of high demand or server overload, the CDN 112 performance may degrade, leading to playback interruptions and reduced streaming quality. In an embodiment, the OTT platforms 114 may correspond to video streaming services or audio streaming services that provide access to a wide range of content, including movies, series, and live broadcasts, via the internet rather than traditional broadcasting. Each OTT platform 114 may operate independently, with its own catalog of content, user interface, and access requirements (e.g., free, subscription-based, or pay-per-view). Further, the OTT platforms 114 may be connected to the CDN 112, which facilitates the delivery of the content to the user device 104. It may be apparent to a person skilled in the art that variations among the OTT platforms 114 may include differences in content libraries, content formats, subscription models, and login requirements, and multiple OTT applications 114 may be installed on the user device 104 to offer potential options for alternate playback if congestion affects the primary OTT platform.

In an embodiment, the OTT catalog 110 may be a content directory accessible by the system 108, storing comprehensive data about the availability of content across various OTT platforms 114. The catalog 110 may be integrated with third-party services or managed as an independent content database, including metadata such as title, episode, and current availability on specific OTT platforms 114. Further, the catalog 110 may enable the system 108 to search for media content on alternate OTT platforms 114 and determine which services provide the desired content. In an embodiment, the catalog 110 may also provide details on deep links and user subscription status, aiding the system 108 in making informed decisions about switching platforms. In an embodiment, the system 108 is a specialized component connected to the network 106, responsible for monitoring playback quality and managing the switch to an alternate OTT platform when the CDN congestion is detected. The system 108 may be designed to identify when playback interruptions occur on the user device 104 and to facilitate the transition to an alternate OTT platform to maintain seamless playback. Further, the system 108 may perform searches across multiple OTT platforms 114 for content availability, gather playback information, and manage the transition, thus ensuring continuous streaming even under network congestion. In an embodiment, the system 108 may operate as an application on the user device 104, a cloud-based service, or a combination of both, depending on the desired implementation, without departing from the scope of the disclosure.

In operation, when the user 102 initiates media playback on a primary OTT platform through the user device 104, the media content is streamed via the CDN 112 over the network 106. During streaming, if congestion arises in the CDN 112, it may result in buffering or interruptions that disrupt playback. The system 108 may actively monitor playback quality on the user device 104 by analyzing network behavior and streaming performance metrics. Upon detecting congestion or impending interruptions, the system 108 may query the catalog 110 for alternate OTT platforms that offer the same content. Thereafter, using data from the catalog 110, the system 108 may identify potential OTT platforms, rank them according to user preferences or login status, and select the most suitable alternate OTT platform 114 for seamless playback. Once the user 102 consents to switch, the system 108 may transition playback to the alternate OTT, using the playback position from the primary OTT to resume content from the exact point of interruption. The user 102 experience may remain uninterrupted, as the system 108 may intelligently manage playback to adapt to network congestion, ensuring smooth and continuous media streaming across multiple OTT platforms 114.

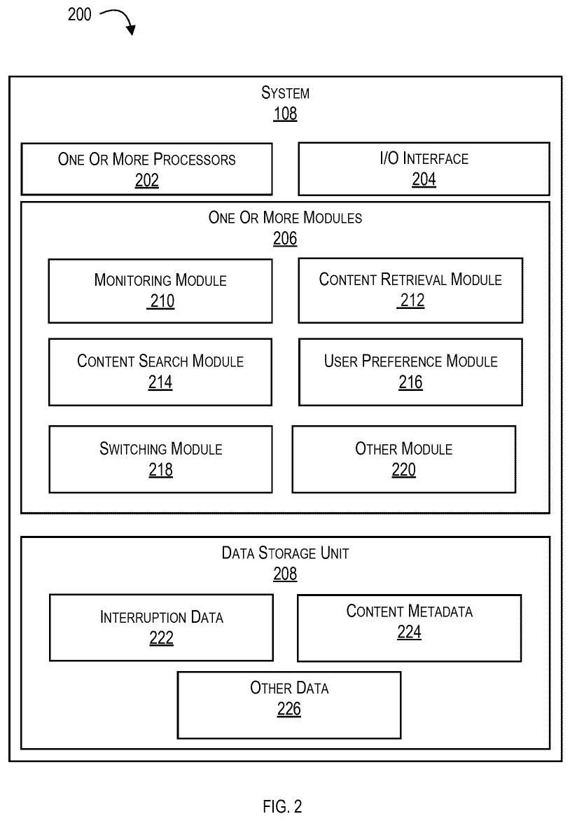

FIG. 2 illustrates a block diagram 200 of the system 108 for switching to the OTT application when congestion occurs in the CDN, in accordance with an embodiment of the present disclosure.

In an embodiment, the system 108 may include one or more processors 202, an Input/Output (I/O) interface 204, one or more modules 206, and a data storage unit 208. The one or more processors 202 may be implemented as one or more microprocessors microcomputers, microcomputers, digital signal processors, central processing units, state machines, logic circuitries, and/or any devices that manipulate signals based on operational instructions. Further, the I/O interface 204 may serve as the pivotal bridge connecting the internal processes of the system 108 with its external environment for facilitating the exchange of information between the system 108 and its users or external devices. Furthermore, the I/O interface 204 may contribute to the user experience by providing intuitive means for input, such as through keyboards or touchscreens, and presenting meaningful output via displays or other output devices. In an embodiment, the one or more modules 206 may include a monitoring module 210, a content retrieval module 212, a content search module 214, a user preference module 216, a switching module 218, and any other modules 220 essential or required for the working of the system 108. In an embodiment, the data storage unit 208 may store interruption data 222, content metadata 224, and other data 226 required for the working of the system 108. In an embodiment of the present disclosure, the one or more processors 202 and the data storage unit 208 may form a part of a chipset installed in the system 108. In another embodiment of the present disclosure, the data storage unit 208 may be implemented as a static memory or a dynamic memory. For example, the data storage unit 208 may be internal to the system 108, such as an onside-based storage. In another example, the data storage unit 208 may be external to the system 108, such as cloud-based storage. Further, the one or more module 206 may be communicatively coupled to the data storage unit 208 and the one or more processor 202 of the system 108. The one or more processors 202 may be configured to control the operations of the one or more modules 206.

In an embodiment, the monitoring module 210 may detect interruptions in the playback of media content on a primary OTT application due to congestion in the CDN 112, enabling a seamless user experience by preemptively identifying potential disruptions. In one embodiment, such detections are performed by analyzing playback logs during streaming to detect deviations in the expected frequency of video or audio data, which may indicate an interruption. In another embodiment, the monitoring module 210 may capture screenshots of the playback screen and apply object detection techniques to identify buffering icons or indicators. In yet another embodiment, the monitoring module 210 may inspect the document object model (DOM) of the streaming application to find elements commonly associated with buffering states, such as specific HTML tags or IDs with terms related to buffering. Additionally, or alternatively, the monitoring module 210 may also anticipate future interruptions by monitoring the rate at which video or audio segments are prefetched, comparing this rate to an expected threshold, and noting any significant decline or mismatch as a sign of impending playback issues.

Further, the monitoring module 210 may be configured to operate across multiple types of playback logs, including system-level logs or application-specific logs, to ensure comprehensive detection. In an embodiment, the monitoring module 210 may vary in analysis method by adapting to different user devices and OTT applications, allowing it to tailor its detection criteria based on the platform's specifications and common failure patterns. For instance, the monitoring module 210 may detect interruptions by monitoring device-level signals like network latency spikes or packet loss rates, to detect congestion even before the application itself experiences a buffering. Furthermore, in some implementations, the monitoring module 210 may utilize machine learning to continuously improve its identification of interruption patterns based on historical data, optimizing accuracy in recognizing buffering or stalling issues. Additionally, the monitoring module 210 may utilize audio signals from the playback to detect if the audio stream lags, signaling a potential delay before the video freezes, thereby further enhancing preemptive detection of interruptions.

In an embodiment, the content retrieval module 212 may fetch essential metadata related to the media content currently being streamed on a primary OTT application, enabling a seamless transition to an alternate OTT platform in case of playback interruptions. In an embodiment, the metadata may, without any limitation, include the title and playback position of the content, which are critical for ensuring continuity if a switch is necessary. Further, the content retrieval module 212 may extract the metadata through various means, such as accessing logs, reading on-screen information, or leveraging APIs that provide access to streaming data from the primary OTT application. Furthermore, the playback position may be obtained directly from the progress bar or by recording the timestamp where the video/audio is paused, ensuring that the switch to an alternate platform resumes the content from the exact point of interruption. In an embodiment, the content retrieval module 212 may operate across a variety of OTT applications and formats, adapting its methods based on the metadata accessibility of each platform. Further, the content retrieval module 212 may retrieve additional metadata beyond the title and playback position, such as episode number, season, genre, or even language preferences, allowing for a more tailored experience when switching between platforms. Additionally, the content retrieval module 212 may retrieve such metadata by incorporating optical character recognition (OCR) on screenshots to capture on-screen text when traditional APIs are unavailable. In an additional embodiment, the content retrieval module 212 may communicate with third-party services that store user watch history to pull accurate playback metadata, without departing from the scope of the present disclosure.

In an embodiment, the content search module 214 may identify alternate OTT applications 114 that can continue streaming the same media content when congestion is detected in the CDN 112 affecting the primary OTT application. Based on metadata retrieved from the primary OTT, such as title and playback position, the content search module 214 may search for other OTT platforms 114 capable of providing access to the same content. In an embodiment, the content search module 214 may utilize a third-party catalog or content directory or the OTT catalog 110 to verify availability across various OTT applications 114, providing a deep link to the most appropriate alternate OTT application. Additionally, the content search module 214 may be designed to assess user preferences and prioritize platforms that align with the user's login status, subscription level, or frequently used applications. Such preference-based ranking ensures that the transition is not only seamless but also considers the user's pre-established relationships with other OTT providers. In an embodiment, the content search module 214 may be adapted to conduct more complex searches across multiple content catalogs by integrating metadata from global catalogs or region-specific directories to increase accuracy and coverage. In one variation, the content search module 214 may search for content availability based on regional licenses, filtering results according to the user's location to ensure legal access. Additionally, the content search module 214 may retrieve additional parameters, such as content quality, subtitle options, and language availability to match the original playback environment more closely and may incorporate machine learning algorithms to learn user preferences over time, enhancing the personalization of its recommendations. In an additional embodiment, the content search module 214 may have the capability to determine whether the alternate OTT applications 114 are installed on the user device 104; if not, the content search module 214 may suggest installations or alternative browser-based streaming options.

In an embodiment, the user preference module 216 may prioritize alternate OTT applications according to the user's subscription status and preferences, optimizing the selection process for a smoother transition. In scenarios, when multiple OTT applications 114 are available to provide access to the same media content, the user preference module 216 may rank them according to the user's subscriptions, frequently used platforms, and login status, highlighting the highest-ranked application for a seamless transition. In an embodiment, the user preference module 216 may adapt to additional criteria, such as recent user behavior, preferred video/audio quality, and content accessibility options, like subtitles or language settings. In some embodiments, the user preference module 216 may dynamically adjust rankings based on real-time feedback, such as recent playback issues or application performance history. Additionally, the user preference module 216 may incorporate social recommendations, suggesting platforms popular among the user's social circle or showing trending apps for similar content. In an additional embodiment, the user preference module 216 may retrieve and store user preference data across multiple devices, allowing it to maintain consistent recommendations in multi-device setups.

In an embodiment, the switching module 218 may initiate, once an appropriate alternative is identified, the transition of playback to the selected OTT application from the exact point of interruption. To ensure a seamless viewing experience, the switching module 218 may utilize the playback position data retrieved earlier, transmitting it to the new OTT application so that playback resumes precisely where it left off on the primary OTT platform. The switching module 218 may utilize deep linking to navigate directly to the alternate OTT platform, ensuring that the transition feels natural and minimizes disruption to the viewing experience. In an embodiment, the switching module 218 may adapt to multiple OTT applications, using platform-specific APIs to set playback positions accurately, and even adjusting quality settings to match the initial viewing experience. In an embodiment, the switching module 218 may offer multi-device support, enabling the playback switch to occur on a different device if the user 102 has logged into the alternate OTT app on another platform, such as a smart TV or tablet. Additionally, the switching module 218 may capture additional viewing preferences, such as subtitle settings, audio language, or screen brightness, and automatically apply these preferences on the new OTT platform to maintain a consistent experience. In an additional embodiment, the switching module 218 may integrate with cross-platform playback solutions that enable syncing across multiple devices, providing users with greater flexibility.

In an embodiment, the other modules 220 may include a notification module and a quality assessment module. The notification module may notify the user 102 about the interruption, provide options for switching to an alternate OTT, and display information on the newly selected OTT application. The notification module may be implemented in scenarios if user input is needed or if the user 102 wants to control the switching process. The quality assessment module may ensure optimal playback by assessing the quality (e.g., resolution, bitrate) of the current stream on the primary OTT and comparing it with the potential quality on the alternate OTT.

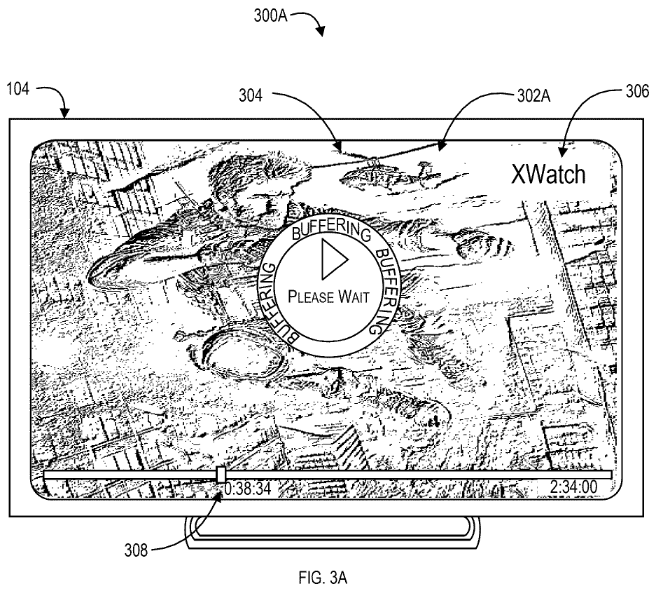

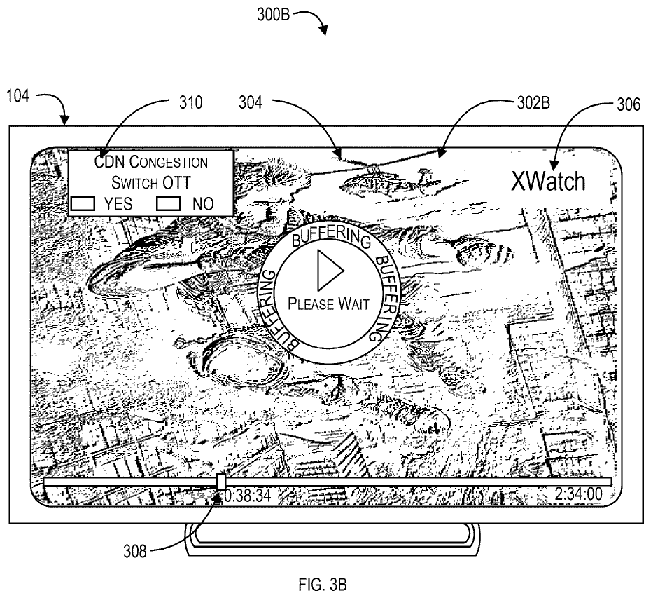

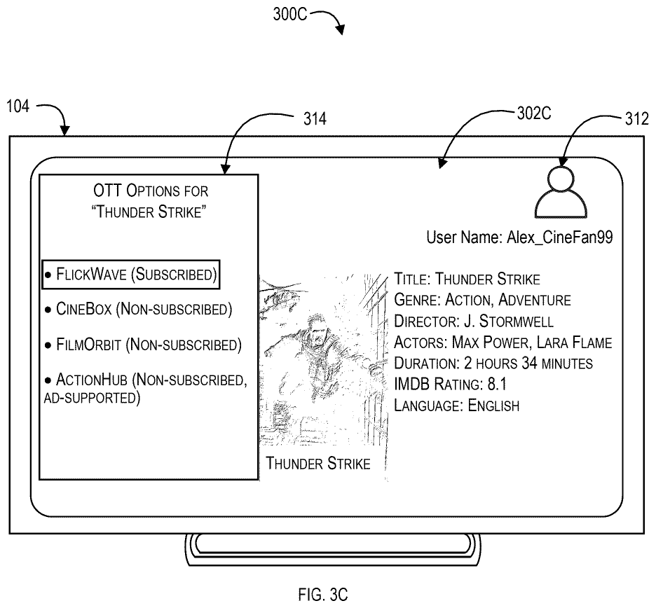

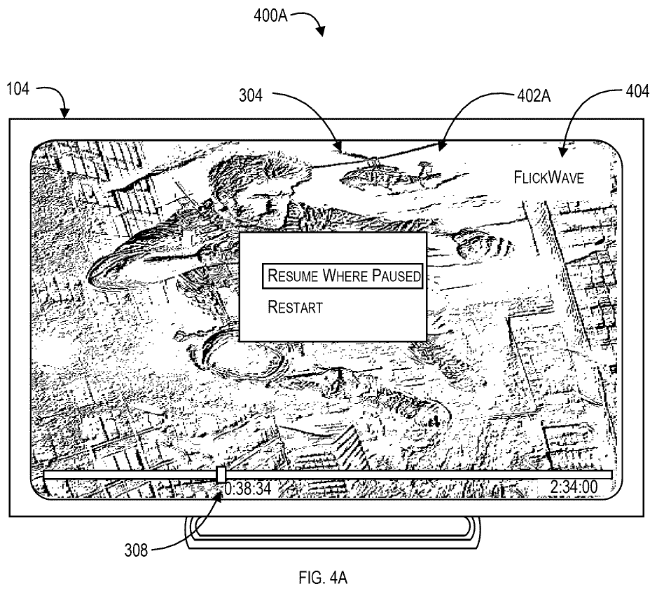

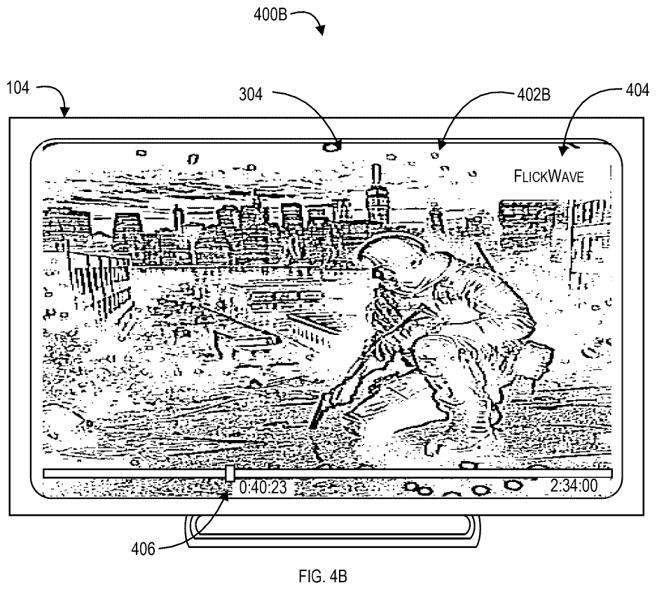

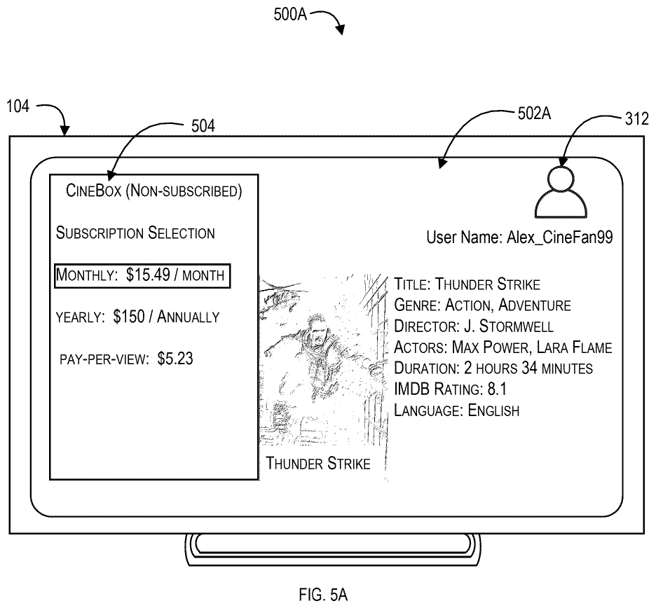

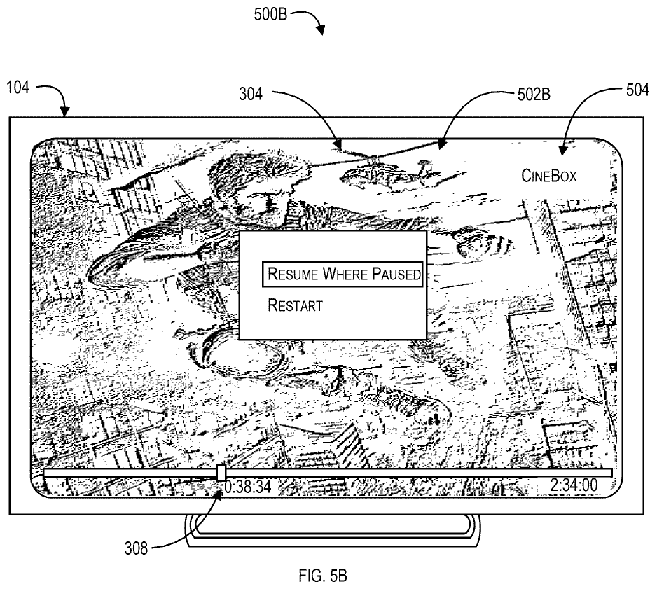

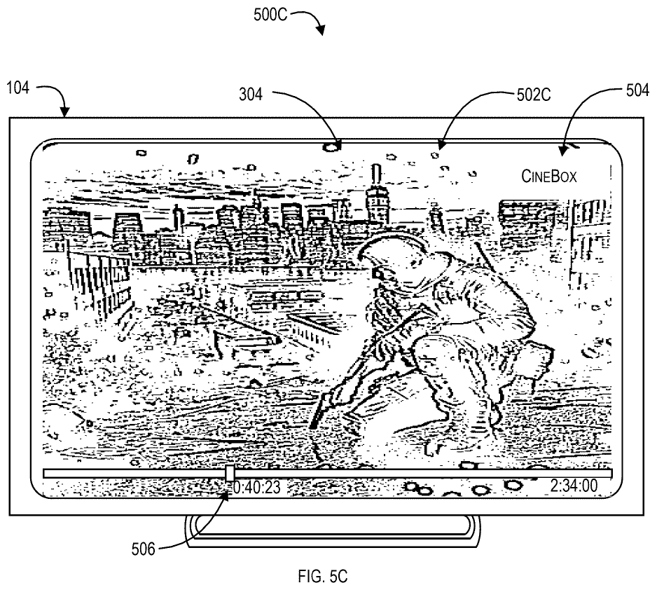

FIGS. 3A-3C illustrate exemplary implementations 300A-300C of the system 108 for switching to the OTT application 114 when congestion occurs in the CDN 112, in accordance with an embodiment of the present disclosure. FIGS. 4A-4B illustrate exemplary implementations 400A-400B of the system 108 for switching to a subscribed alternate OTT application, in accordance with an embodiment of the present disclosure. FIGS. 5A-5C illustrate exemplary implementations 500A-500C of the system 108 for switching to an unsubscribed alternate OTT application, in accordance with an embodiment of the present disclosure. For the sake of brevity, FIGS. 3A-3C, 4A-4B, and 5A-5C have been explained together.

In an embodiment, as illustrated in an exemplary interface 302A of the user device 104, media content may be getting streamed on the XWatch OTT platform 306 and displays a content playback screen where the media content 304 is buffering signifying an interruption in streaming, likely due to network congestion or CDN limitations affecting the XWatch OTT platform 306. Further, the exemplary interface 302A also illustrates a progress bar 308 prominently shown below the media content 304 indicating the playback position of the video/audio in real-time, providing both the elapsed and total duration of the content. In this instance, the progress bar 308 shows that buffering is occurring at the timestamp 00:38:34, reflecting the current position in the video/audio where playback has stalled, wherein, the total length of the content is 2:34:00, indicating that the user 102 has more than two hours remaining to watch once buffering resolves. Additionally, the exemplary interface 302A may also include the visual representation of buffering which may, without any limitation, include a spinning icon or “buffering” message overlaying the media content 304 alerting the user 102 to the fact that video/audio playback is paused temporarily.

Further, as illustrated in the exemplary interface of 302B of the user device 104, once the congestion is detected, a notification 310 may be sent to the user 102. The notification 310 may appear as an overlay message on the screen of the user device 104, alerting the user 102 to the detected “CDN Congestion” and informing them of the available option to switch to an alternate OTT platform 114 to continue watching the media content 304 without further buffering. In addition to conveying information about the CDN congestion, the notification 310 may also provide two interactive options labeled “Yes” and “No”. By selecting “Yes,” the user 102 may consent to switch to an alternative OTT platform where the same content is available, allowing playback to continue from the exact position where buffering occurred. By selecting “No,” the user 102 may choose to remain on the current OTT platform (XWatch) and wait for the buffering issue to resolve on its own.

When the user selects the option “yes” to switch to an alternate OTT platform, the exemplary interface 302C may be displayed to the user 102, showing the user ID 312, details of the content (such as title, genre, director, actor, or the like), and a list 314 of alternate OTT platforms for the user 102. The list 314 may allow the user 102 to select an alternate platform to resume playback and may include a combination of subscribed OTT platforms (where the user holds an active subscription) and non-subscribed OTT platforms where each platform may be presented as a selectable option, allowing the user to make an informed choice based on availability, subscription status, and preference. For example: a first platform which may be a top-ranked, subscribed OTT platform, is prioritized as it may provide a seamless transition without additional login requirements, and a second platform which may be a non-subscribed platform that offers the same content but may require the user to either login or subscribe, allowing the user flexibility if the other options are unavailable.

In an embodiment, as illustrated in exemplary interface 402A of the user device 104, when the user 102 selects an alternate subscribed OTT platform (for example, FlickWave) 404, then the user 102 may be presented with two options i.e. “resume where paused” and “restart”. The “resume where paused” may allow the user 102 to continue watching the media content from the exact playback position where it was paused or interrupted on the initial OTT platform. For example, if the video was interrupted at 00:38:34 (as shown in FIG. 3A), selecting this option would start the playback from that same timestamp, as shown in exemplary interface 402B, ensuring continuity (as shown by the progress bar 406) in the viewing experience without having to manually locate the paused position. Further, the “restart” option allows the user 102 to start the video from the beginning, disregarding the previous playback position. Thus, selecting “Restart” will play the content from 00:00:00, which might be preferred if the user 102 wants to re-watch the content from the start or if they had only watched a small portion before the interruption.

In an embodiment, as illustrated in exemplary interface 502A of the user device 104, when the user 102 selects an alternate non-subscribed OTT platform 504 (for example, CineBox), then the user 102 may be presented with subscription selection window having options like monthly subscription, yearly subscription, or pay-per-view subscription. Once the user 102 subscribes to the alternate OTT platform, then the user 102, as illustrated in exemplary interface 502B of the user device 104, may be presented with two options i.e. “resume where paused” and “restart”. The “resume where paused” may allow the user 102 to continue watching the media content from the exact playback position where it was paused or interrupted on the initial OTT platform. For example, if the video was interrupted at 00:38:34 (as shown in FIG. 3A), selecting this option would start the playback from that same timestamp, as shown in exemplary interface 402C, ensuring continuity (as shown by the progress bar 506) in the viewing experience without having to manually locate the paused position. Further, the “restart” option allows the user 102 to start the video from the beginning, disregarding the previous playback position. Thus, selecting “Restart” will play the content from 00:00:00, which might be preferred if the user 102 wants to re-watch the content from the start or if they had only watched a small portion before the interruption.

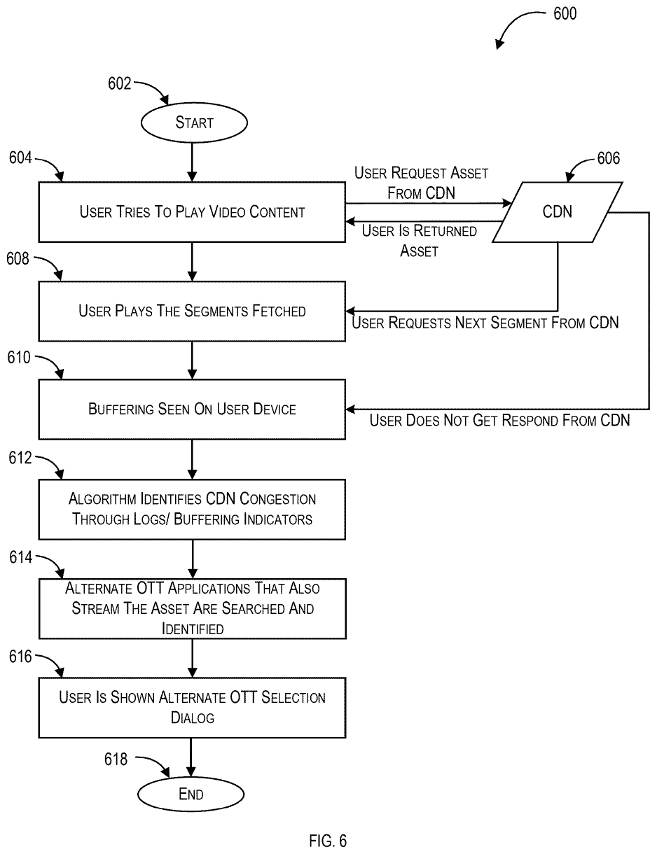

FIG. 6 illustrates a flow chart 600 for an operation of the system 108 for switching to the OTT application when congestion occurs in the CDN, in accordance with an embodiment of the present disclosure. The operation may start at step 602.

At first, the user 102 may try to play the media content, at step 604, by requesting an asset from CDN 606 (hereinafter CDN has been marked 606 for understanding of operation but is same as CDN 112) and receiving the requested asset from the CDN 606. Next, at step 608, the user 102 may request the next segment of the asset from the CDN 606 to play the fetched segment on the user device 104. In some scenarios, as shown by step 610, the user 102 may not receive a response from the CDN and thus buffering may be seen on the user device 104. Next, at step 612, the system 108 may detect the CDN congestion through logs and/or buffering indicators, as explained in previous paragraphs. Upon detecting congestion or impending interruptions, the system 108 may query the catalog 110 for alternate OTT platforms that offer the same content. Next, at step 614, using data from the catalog 110, the system 108 may identify potential OTT platforms, rank them according to user preferences or login status, and select the most suitable alternate OTT platform 114 for seamless playback. Thereafter, at step 616, the user 102 is shown the alternate OTT selection dialog. Once the user 102 consents to switch, the system 108 may transition playback to the alternate OTT, using the playback position from the primary OTT to resume content from the exact point of interruption. The user 102 experience may remain uninterrupted, as the system 108 may intelligently manage playback to adapt to network congestion, ensuring smooth and continuous media streaming across multiple OTT platforms 114.

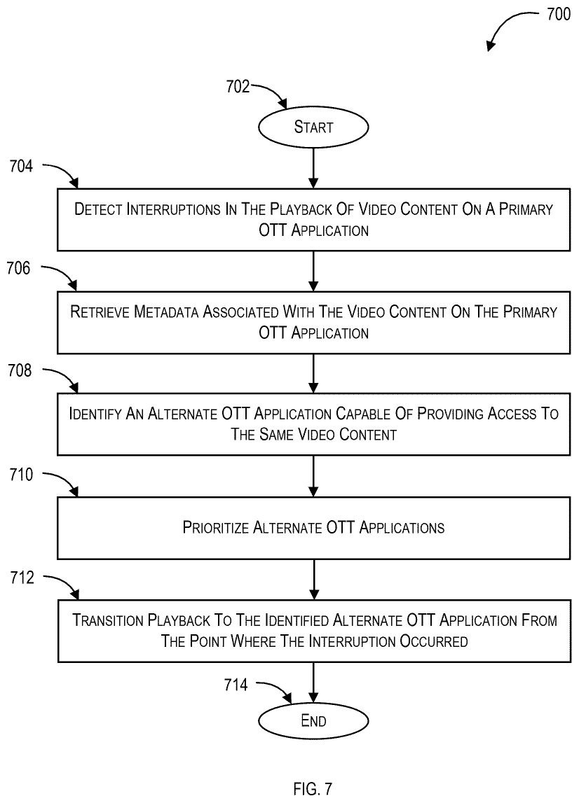

FIG. 7 is a flow chart 700 of a method for switching to the OTT application when congestion occurs in the CDN. The method starts at step 702.

At first, at step 704, interruptions in the playback of media content on a primary OTT application may be detected. Such interruptions may be associated with CDN congestion. In an embodiment, the detection of interruptions may be achieved by analyzing playback logs for deviations in expected video or audio data frequency, capturing and analyzing screenshots for buffering indicators using an object detection model, or inspecting the document object model (DOM) of the streaming application to identify elements associated with buffering states. Further, detection of interruptions may include preemptively detecting potential interruptions by monitoring the prefetch rate of video or audio segments and comparing it to an expected rate.

Next, at step 706, metadata associated with the media content on the primary OTT application may be retrieved. The metadata may include the title and playback position of the media content, enabling the system to locate the same content on other OTT platforms. Next, at step 708, alternate OTT applications capable of providing access to the same media content based on this metadata may be identified. The identification of alternate OTT applications may include the steps of determining if the alternate OTT application is installed on the user's device and, if so, providing a deep link to facilitate the switch. Alternatively, or additionally, identifying the alternate OTT application may include searching a third-party catalog for the availability of the media content on various OTT applications and ranking these options based on user preferences and login status.

Next, at step 708, alternate OTT applications may be prioritized according to the user's subscription status and preferences, optimizing the selection process for a smoother transition. Thereafter, at step 710, the transition of playback to the selected OTT application from the exact point of interruption may be initiated. To ensure a seamless viewing experience, the method may utilize the playback position data retrieved earlier, transmitting it to the new OTT application so that playback resumes precisely where it left off on the primary OTT platform. In addition, the method may allow playback to be restored from the same scene or timestamp by retrieving the title, episode details, and play position before switching. The method ends at step 714.

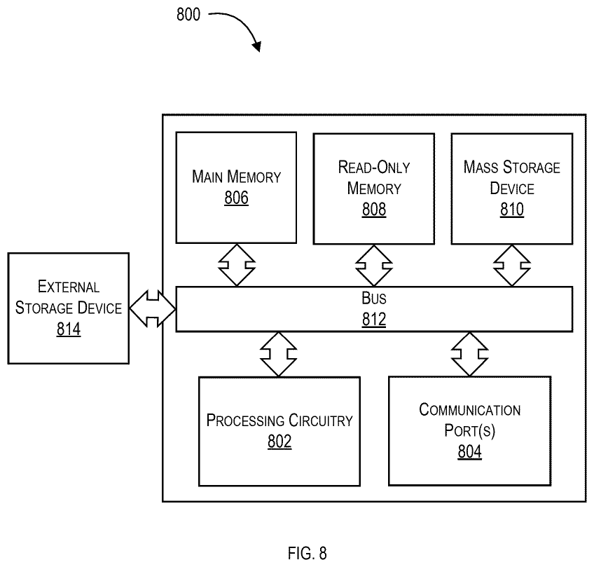

FIG. 8 illustrates an exemplary computer system in which or with which embodiments of the present disclosure may be utilized. As shown in FIG. 8, a computer system 800 includes an external storage device 814, a bus 812, a main memory 806, a read-only memory 808, a mass storage device 810, a communication port 804, and a processor 802.

Those skilled in the art will appreciate that computer system 800 may include more than one processor 802 and communication ports 804. Examples of processor 802 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 802 may include various modules associated with embodiments of the present disclosure.

The communication port 804 can be any of an RS-232 port for use with a modem-based dialup connection, a 10/100 Ethernet port, a Gigabit or 10 Gigabit port using copper or fiber, a serial port, a parallel port, or other existing or future ports. The communication port 804 may be chosen depending on a network, such as a Local Area Network (LAN), Wide Area Network (WAN), or any network to which the computer system connects.

The memory 806 can be Random Access Memory (RAM), or any other dynamic storage device commonly known in the art. Read-Only Memory 808 can be any static storage device(s) e.g., but not limited to, a Programmable Read-Only Memory (PROM) chips for storing static information e.g., start-up or BIOS instructions for processor 802.

The mass storage 810 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 812 communicatively couples processor(s) 802 with the other memory, storage, and communication blocks. The bus 812 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 802 to a software system.

Optionally, operator and administrative interfaces, e.g., a display, keyboard, and a cursor control device, may also be coupled to bus 812 to support direct operator interaction with the computer system. Other operator and administrative interfaces can be provided through network connections connected through communication port 804. An external storage device 814 can be any kind of external hard-drives, floppy drives, IOMEGA® Zip Drives, Compact Disc Read-Only Memory (CD-ROM), Compact Disc-Re-Writable (CD-RW), Digital Video Disk Read Only Memory (DVD-ROM). The components described above are meant only to exemplify various possibilities. In no way should the aforementioned exemplary computer system limit the scope of the present disclosure.

The disclosed system, method, and computer program product (together termed as ‘disclosed mechanism’) for image content moderation tailored for hybrid radio broadcasts offers a tailored solution that enhances user control and content filtering. By seamlessly receiving, analyzing, and scoring images accompanying broadcasted programs, the mechanism effectively anticipates and identifies potentially offensive content, thereby significantly enhancing user satisfaction and contentment. Leveraging advanced Machine Learning (ML) algorithms and sophisticated image recognition techniques, the mechanism ensures precise detection of inappropriate material, fostering a more secure and enjoyable user experience. Moreover, its dynamic decision-making process enables adaptable image display, allowing users to customize their content consumption based on personal preferences or predefined moderation thresholds. Furthermore, the mechanism offers alternative images devoid of offensive content and adds an extra layer of assurance, bolstering user satisfaction. Additionally, the mechanism's dynamic decision-making capabilities enable swift action to be taken, ensuring that only appropriate and safe visual content is delivered, thus mitigating the risk of exposure to undesirable material.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art

What is claimed is:

1. A system for switching to an alternate over-the-top (OTT) application when congestion occurs in a content delivery network (CDN), the system comprising:
a monitoring module configured to detect interruptions in the playback of media content on a primary OTT application, wherein the interruptions are associated with congestion in the CDN;
a content retrieval module configured to retrieve metadata associated with the media content on the primary OTT application, including at least title and playback position;
a content search module configured to identify an alternate OTT application capable of providing access to the same media content based on the retrieved metadata;
a user preference module configured to prioritize alternate OTT applications based on user preferences and subscription status; and
a switching module configured to transition playback to the identified alternate OTT application from the point where the interruption occurred, thereby allowing seamless continuation of the media content.

2. The system of claim 1, wherein the monitoring module detects interruptions in playback by analyzing playback logs to determine a deviation in the expected frequency of video or audio data during streaming.

3. The system of claim 1, wherein the monitoring module detects interruptions in playback by capturing a screenshot of the playback screen and analyzing the screenshot for a buffering indicator using an object detection model.

4. The system of claim 1, wherein the monitoring module detects interruptions by inspecting the document object model (DOM) of the streaming application to identify elements associated with buffering states.

5. The system of claim 1, wherein the monitoring module further detects potential future interruptions by monitoring the rate of prefetching video or audio segments and comparing it to an expected rate.

6. The system of claim 1, wherein the content search module determines whether the alternate OTT application is installed on the user's device and provides a deep link for switching to the alternate OTT application if available.

7. The system of claim 1, wherein the content search module searches a third-party catalog for the availability of the media content on one or more alternate OTT applications.

8. The system of claim 1, wherein the content search module ranks alternate OTT applications based on user preferences or login status and provides the highest-ranked application for seamless transition.

9. The system of claim 1, wherein the switching module retrieves the title, episode, and playback position of the media content in the primary OTT application prior to switching.

10. The system of claim 9, wherein the switching module transmits the playback position to the alternate OTT application to continue playback from the same point of interruption.

11. A method for switching to an alternate over-the-top (OTT) application when congestion occurs in a content delivery network (CDN), the method comprising:
detecting interruptions in the playback of media content on a primary OTT application, wherein the interruptions are associated with congestion in the CDN;
retrieving metadata associated with the media content on the primary OTT application, including at least title and playback position;
identifying an alternate OTT application capable of providing access to the same media content based on the retrieved metadata;
prioritizing alternate OTT applications based on user preferences and subscription status; and
transitioning playback to the identified alternate OTT application from the point where the interruption occurred, thereby allowing seamless continuation of the media content.

12. The method of claim 11, wherein the detection of interruptions in playback further comprises analyzing playback logs to determine a deviation in the expected frequency of video or audio data during streaming.

13. The method of claim 11, wherein the detection of interruptions in playback further comprises capturing a screenshot of the playback screen and analyzing the screenshot for a buffering indicator using an object detection model.

14. The method of claim 11, wherein the detection of interruptions in playback further comprises inspecting the document object model (DOM) of the streaming application to identify elements associated with buffering states.

15. The method of claim 11, wherein the detection of interruptions in playback further comprises detecting potential future interruptions by monitoring the rate of prefetching video or audio segments and comparing it to an expected rate.

16. The method of claim 11, further comprises determining whether the alternate OTT application is installed on the user's device and provides a deep link for switching to the alternate OTT application if available.

17. The method of claim 11, further comprises searching a third-party catalog for the availability of the media content on one or more alternate OTT applications.

18. The method of claim 11, further comprises ranking alternate OTT applications based on user preferences or login status and provides the highest-ranked application for seamless transition.

19. The method of claim 11, further comprises retrieving the title, episode, and playback position of the media content in the primary OTT application prior to switching.

20. The method of claim 19, further comprises transmitting the playback position to the alternate OTT application to continue playback from the same point of interruption.
